(19) United States
(12) Patent Application Publication
(10) Pub. No.: US 2015/0345563 A1
(43) Pub. Date: Dec. 3, 2015

(54) BEARING POWER GENERATING CONFIGURATION

(71) Applicant: AKTIEBOLAGET SKF, Göteborg (SE)

(72) Inventors: Frank BARTL, Neuenburg am Rhein (DE); Joseph ERSKINE, Falkirk (GB); Andreas Clemens VAN DER HAM, Utrecht (NL); Sebastian ZIEGLER, Utrecht (NL)

(21) Appl. No.: 14/648,829

(22) PCT Filed: Dec. 5, 2012
(86) PCT No.: PCT/EP2012/074538

§ 371 Date: Jun. 1, 2015

(51) Int. Cl. F16C 41/00; H02K 7/08; H02K 7/18; F16C 33/78

(52) U.S. Cl. CPC F16C 41/004; F16C 33/7886; H02K 7/08; H02K 7/1846

(57) ABSTRACT

A power generating bearing assembly comprising a power generating subassembly integrated into a bearing. The power generating subassembly utilizes the relative motion between a bearing inner ring and a bearing outer ring of the bearing to generate electrical power. A seal lip comprises a seal lip inner ring lip engaging segment which slideably engages with an inner ring sealing lip surface of the offset bearing. A magnetically polarized material is supported by a magnetically polarized material-supporting segment of the bearing assembly seal lip. Engagement between the inner ring lip engaging segment and the lip surface retains radial registration between the magnetically polarized material and a generator core. During operation, relative motion between the magnetically polarized material and a generator core caused by rotation of the bearing rings generates an electrical output.

### CROSS REFERENCE TO RELATED APPLICATIONS

This is a United States National Stage application claiming the benefit of International Application Number PCT/EP2012/074538 filed on 5 Dec. 2012, which is incorporated herein by reference in its entirety.

### TECHNICAL FIELD OF THE INVENTION

The present invention relates to an apparatus and method for generating power during motion of a bearing.

### BACKGROUND ART

A bearing can be defined as any of various machine elements that constrain the relative motion between two or more parts to only the desired type of motion. This is typically to allow and promote free rotation about a longitudinal axis and/or restrain any linear movement of a component in a normal direction respective to the bearing. Bearings may be classified broadly according to the motions they allow and according to their principle of operation, as well as by the directions of applied loads they can handle.

Bearings undergo significant use, which causes wear to the various bearing components. Over time, the wear on the bearing can result in mechanical failure. Mechanical failure can impact the rotational motion and/or the axial linear restraint. Failure to control either of these movements can cause catastrophic failure to the machinery relying upon the bearing.

Bearing reliability and predictive servicing can impact the operation and uptime of equipment. Bearings are used in many applications, including vehicles, wind turbines, automated machinery, and the like. Over time, the bearings wear. Bearing failure during operation can cause significant damage to the equipment and possibly the surrounding area. The bearing failure could even potentially cause injury or death to people should the right circumstances come occur.

Bearing monitoring systems require power for operation. Power is utilized for operating the condition monitoring sensors, providing power for any computing devices, and providing power for transferring any collected information to a centralized system. The power is provided through wiring to the devices.

Bearing reliability and predictive servicing can be improved by monitoring the bearing. A monitoring system would require power. What is desired is a power generating system associated with the bearing assembly.

### DISCLOSURE OF THE INVENTION

The present invention is directed towards an apparatus and respective method for generating electrical energy during the operation of equipment comprising a bearing.

In a first aspect of the present invention, a power generating bearing assembly, the power generating bearing assembly comprising:

a bearing comprising:
a bearing outer ring having an outer surface, a bearing outer race engaging surface, and an outer ring end surface,
a bearing inner ring having a bearing assembly interior mating surface, a bearing inner race engaging surface, and an inner ring planar end surface, wherein the inner ring bearing inner race engaging surface is sized to rotationally engage with the outer ring bearing outer race engaging surface, in some embodiments the bearing further comprises a series of bearings rollers or balls and where said inner ring is rotationally assembled within said outer ring bearing outer race engaging surface integrating said series of bearings rollers or balls there between,
wherein the inner ring is rotatationally assembled within the outer ring bearing outer race engaging surface and the inner ring end surface stands proud from the outer ring end surface exposing and defining an inner ring sealing lip surface,
a bearing assembly seal lip comprising a bearing assembly seal lip body segmented into a seal lip outer ring attachment segment, a seal lip inner ring lip engaging segment, and a magnetically polarized material supporting segment, the magnetically polarized material supporting segment extending axially from the seal lip inner ring lip engaging segment beyond the inner ring planar end surface,
a magnetically polarized material carried by the magnetically polarized material-supporting segment,
wherein the seal lip outer ring attachment segment is mechanically coupled to the bearing outer ring and a seal lip inner ring lip engaging surface of the seal lip inner ring lip engaging segment slideably engages with the inner ring sealing lip surface; and
an electrical power generator including a generator core to generate electrical power when exposed to an interactively paired magnetically polarized material, the electrical power generator being attached to the bearing inner ring orienting the generator core in a radial direction to operationally engage with the magnetically polarized material;

wherein during operation, engagement between a seal lip inner ring lip engaging surface of the seal lip inner ring lip engaging segment and the inner ring sealing lip surface retains a consistent distance between the magnetically polarized material and an operational face of the electrical power generator and a relative motion between the bearing outer ring and the bearing inner ring passes the magnetically polarized material across the generator core causing the generator core to create an electrical current.

In a second aspect, the system further includes a processing device comprising a set of digital instructions for monitoring and analyzing digital data provided by a condition monitoring system integrated into the bearing assembly.

In another aspect, the sealing system provides for tolerance compensation along a radial direction.

In another aspect, the radial direction tolerance compensation is accomplished by a bearing assembly seal lip, wherein the seal lip engages with an inner ring sealing lip surface retaining a radial position of a magnetically polarized material supporting segment of the bearing assembly seal lip.

In another aspect, the sealing system provides for tolerance compensation along an axial direction.

In another aspect, the axial direction tolerance compensation is accomplished by sizing a height of the magnetically polarized material that is greater than a height of an operational interfacing surface area of the electrical power generator, wherein a differential in height is greater than a predetermined anticipated relative axial motion of the magnetically polarized material respective to the operational interfacing surface area.

In another aspect, the magnetically polarized material can be provided in a complete annular ring; in a single section covering a partial circularly shaped section; or in a series of sections which are spatially at equal radial distances from a bearing ring center.

In another aspect, the electrical power generator further comprises a circumferential gliding material disposed on a surface opposing the magnetically polarized material.

In a further embodiment of the invention, the power generator is reversed in relation to the inner and outer ring. Thus the generator is placed on the outer ring and the seal on the inner ring, which is suitable with an outer ring rotating bearing. In this embodiment a power generating bearing assembly, the power generating bearing assembly comprises a bearing which in turn comprises a bearing inner ring having an inner surface, a bearing inner race engaging surface, and an inner ring end surface, a bearing outer ring having a bearing assembly outer mating surface, a bearing outer race engaging surface, and an outer ring planar end surface, wherein said bearing outer race engaging surface is sized to rotationally engage with said inner ring bearing inner race engaging surface, a series of rollers or balls,
where said inner ring is rotationally assembled within said outer ring bearing outer race engaging surface integrating said series of rollers or balls there between and said outer ring planar end surface stands proud from said inner ring end surface exposing and defining an outer ring sealing lip surface, a bearing assembly seal lip comprising a bearing assembly seal lip body segmented into a seal lip inner ring attachment segment, a seal lip outer ring lip engaging segment, and a magnetically polarized material supporting segment, said magnetically polarized material supporting segment extending axially from said seal lip outer ring lip engaging segment beyond said outer ring planar end surface, a magnetically polarized material carried by said magnetically polarized material supporting segment, where said seal lip inner ring attachment segment is mechanically coupled to said bearing inner ring and a seal lip outer ring lip engaging surface of said seal lip outer ring lip engaging segment slideably engages with said outer ring sealing lip surface; and
an electrical power generator including a generator core to generate electrical power when exposed to an interactively paired magnetically polarized material, said electrical power generator being attached to said bearing outer ring orienting said generator core in a radial direction to operationally engage with said magnetically polarized material, where during operation, engagement between a seal lip outer ring lip engaging surface of said seal lip outer ring lip engaging segment and said outer ring sealing lip surface retains a consistent distance between said magnetically polarized material and an operational face of said electrical power generator and a relative motion between said bearing inner ring and said bearing outer ring passes said magnetically polarized material across said generator core causing said generator core to create an electrical current.

Suitably said bearing assembly seal lip further comprises a seal lip body compliancy formation formed between said seal lip inner ring attachment segment and said seal lip outer ring lip engaging segment. In some versions said magnetically polarized material has an axial dimension that is larger than an axial dimension of said operational face of said electrical power generator to accommodate for axial relative motions between said bearing outer ring and said bearing inner ring during operation. In some versions said magnetically polarized material supporting segment is formed as an annular ring concentric about a central axis of said bearing. In some versions said magnetically polarized material being provided as an annular ring. In some versions said magnetically polarized material being provided in a partial circumference of said annular ring. In some versions said magnetically polarized material being provided in a plurality of segments, said plurality of segments being spatially arranged about a circumference of said continuous ring.

According to the invention a power generating bearing assembly comprises a power generating subassembly integrated into a bearing. The power generating subassembly utilizes the relative motion between a bearing inner ring and a bearing outer ring of the bearing to generate electrical power. A seal lip comprises a seal lip inner or outer ring lip engaging segment which slideably engages with an inner or outer ring sealing lip surface of the offset bearing. A magnetically polarized material is supported by a magnetically polarized material-supporting segment of the bearing assembly seal lip. Engagement between the inner or outer ring lip engaging segment and the lip surface retains radial registration between the magnetically polarized material and a generator core. During operation, relative motion between the magnetically polarized material and a generator core caused by rotation of the bearing rings generates an electrical output.

One advantage of the present invention is the ability to generate a continued electrical current during a relative motion between the inner and outer rings of the bearing subassembly. The power can be utilized to operate bearing condition monitored equipment. The inclusion of an electrical power-generating device eliminates any need for a locally stored power (such as by a battery) or conveyed power from an external power source. By generating power at the location, the system can operate completely independent and un-tethered from any other device by providing sufficient power for wireless signal communications. While yet another advantage is that operation of the monitoring system can be limited to the time where the bearing is undergoing rotation. Power is only applied to the system when the generator is subjected to the relative motion between the bearing outer ring and the bearing inner ring.

Bearings can be utilized on equipment deployed in remote locations. The location could complicate any provisions for externally provided power for monitoring the condition of the bearing. The bearing(s) can be integrated into the equipment at a location that is difficult to access, particularly for wiring. Further, wires can accidentally interfere or become abraded by any rotational movements or other movements of components of the equipment.

Another advantage enables the registration between the electrical power generator and the magnetically polarized material to adapt to changes and wear of the bearing. The mechanical interface includes features to accommodate for radial and axial changes between the electrical power generator and the magnetically polarized material.

The use of a magnetic density operated generator core eliminates any wear and reliability issues associated with moving components. Any contacting surfaces can include bearings, friction reduced surfaces, and the like to minimize any impact resulting from relative motion between two moving components contacting one another.

In a configuration where the sealing system is attached to the bearing inner ring, the centrifugal force ensures the magnetically polarized material remains proximate the generator core. A sealing feature rides against an engaging surface of a rim of the inner ring of the bearing assembly bearing race to retain the radial position of the magnetically polarized material-supporting member, thus preserving the axial relation between the magnetically polarized material supporting member and the electrical power generator. The axial relation between the magnetically polarized material supporting member and the electrical power generator can be a frictional interface or an air gap.

In a configuration where the sealing system is attached to the bearing outer ring, the annular ring shape retains the magnetically polarized material proximate to the generator core.

The different aspects, versions and configurations according to the invention can be combined in any desired manner as long as no conflicting aspects, versions or configurations are combined.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents an exemplary schematic diagram of a bearing condition monitoring system monitoring an exemplary a power generating bearing assembly utilizing power generated by an integrated bearing power generator;

FIG. 2 presents an isometric top view of the power generating bearing assembly originally introduced in FIG. 1;

FIG. 3 presents a sectioned view of the power generating bearing assembly originally introduced in FIG. 1, the section taken along an axial direction identified by section line 3-3 of FIG. 2; and

FIG. 4 presents a magnified sectioned view of the power generating bearing assembly as presented in FIG. 3, wherein the illustration enhances details of the integrated bearing power generator.

Like reference numerals refer to like parts throughout the several views of the drawings.

### MODES FOR CARRYING OUT THE INVENTION

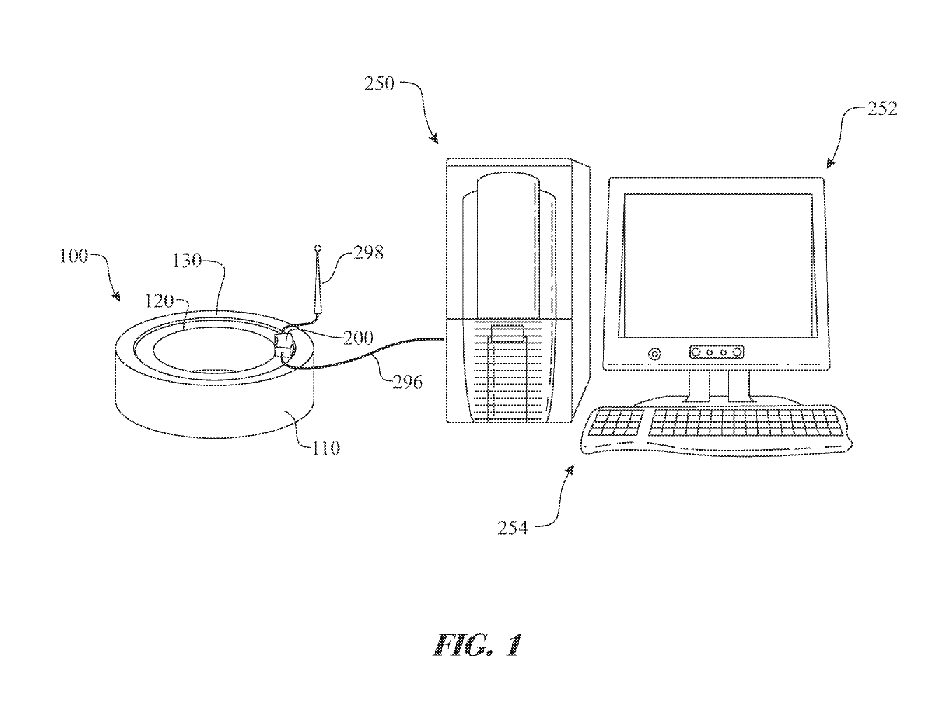

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A generic exemplary system schematic is presented in FIG. 1. The generic system includes a power generating bearing assembly 100 comprising a power generating subassembly 200 integrated into a bearing subassembly 110. The bearing subassembly 110 is fabricated having a bearing inner ring 120 assembled within a bearing outer ring 130, wherein the interface between the bearing inner ring 120 and the bearing outer ring 130 restrains the relative motion to a rotational motion about a central axis. Commonly the interface between the bearing inner ring 120 and the bearing outer ring 130 comprises a set of roller or balls. The relative rotational motion provided between the bearing inner ring 120 and the bearing outer ring 130 passes a magnetically polarized material 324 across a generator core 312 to generate electrical energy in a form of an electrical current. In addition to power generating elements, the power generating subassembly 200 can include a sensor, a digital signal processor or any other device to embed a digital data signal within a current. The digital data signal is transmitted to a processing unit 250 via a wired signal interface 296 or preferably via a wireless signal interface 298. The wireless signal interface 298 includes circuitry and components respective to any selected wireless transmitting protocol. Power would be provided by the power generating subassembly 200 to operate the wireless signal interface 298.

The processing device 250 includes common digital data processing components, include a circuit board, at least one microprocessor, memory, a data recording device, digital instructions (such as software, firmware, and the like), input/output controllers, data communication devices, and the like. A user input device 254 and a user output device 252 are connected in signal communication to the processing device 250 through the input/output controllers and respective cabling. The digital data signal is received by the processing unit 250 and interpreted accordingly. The digital data signal would be provided when the power generating bearing assembly 100 is subjected to movement. The relative movement between the bearing inner ring 120 and the bearing outer ring 130 causes the power generating subassembly 200 to generate electrical power. Therefore, the electrical power is only available when the bearing inner ring 120 and bearing outer ring 130 are in relative motion to one another. It is understood that electrical power can be stored in a capacitor or battery integrated within the power generating subassembly 200. This would enable short cycles of additional power for continued operation after the bearing inner ring 120 and bearing outer ring 130 become stationary respective to one another. This would be beneficial for recording conditions of the bearing subassembly 110 after halting any operation, during cool down, and the like. The system can be recording conditions such as temperature, and the like.

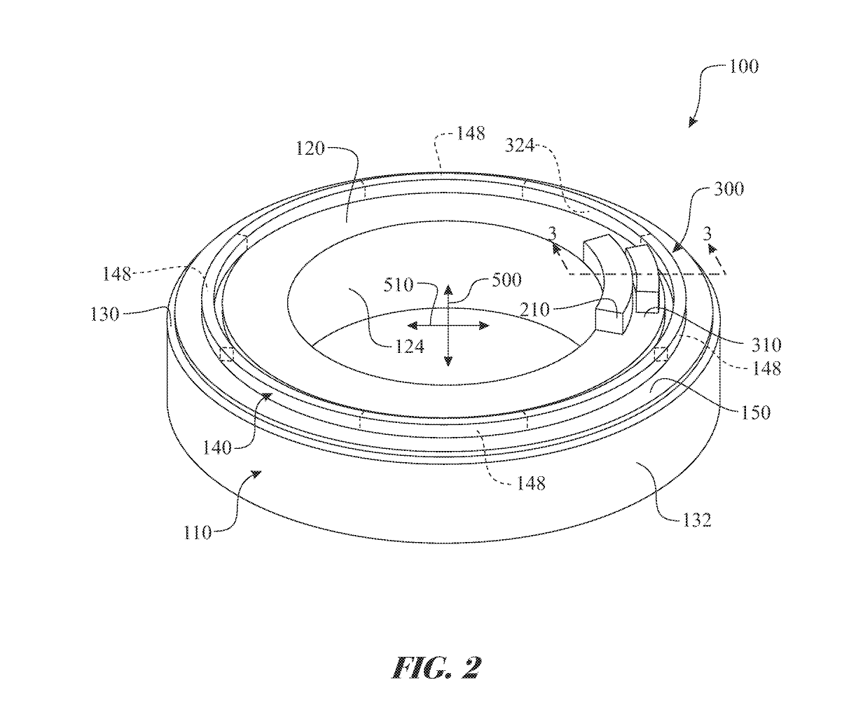

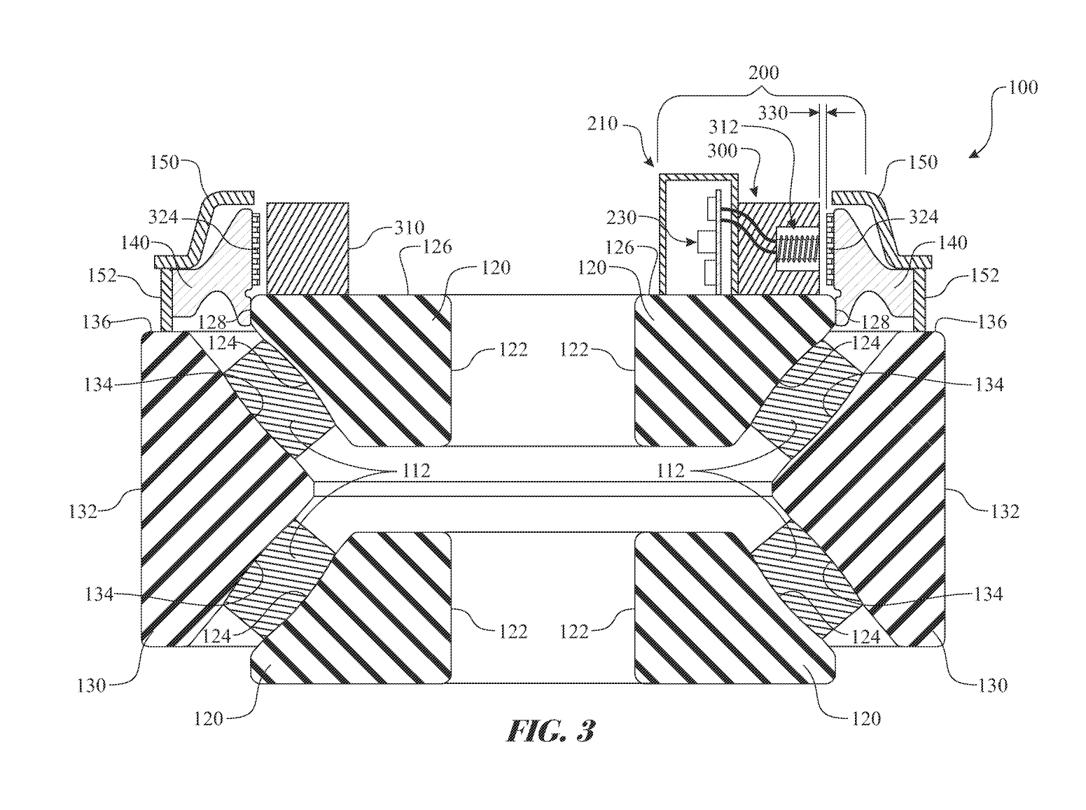

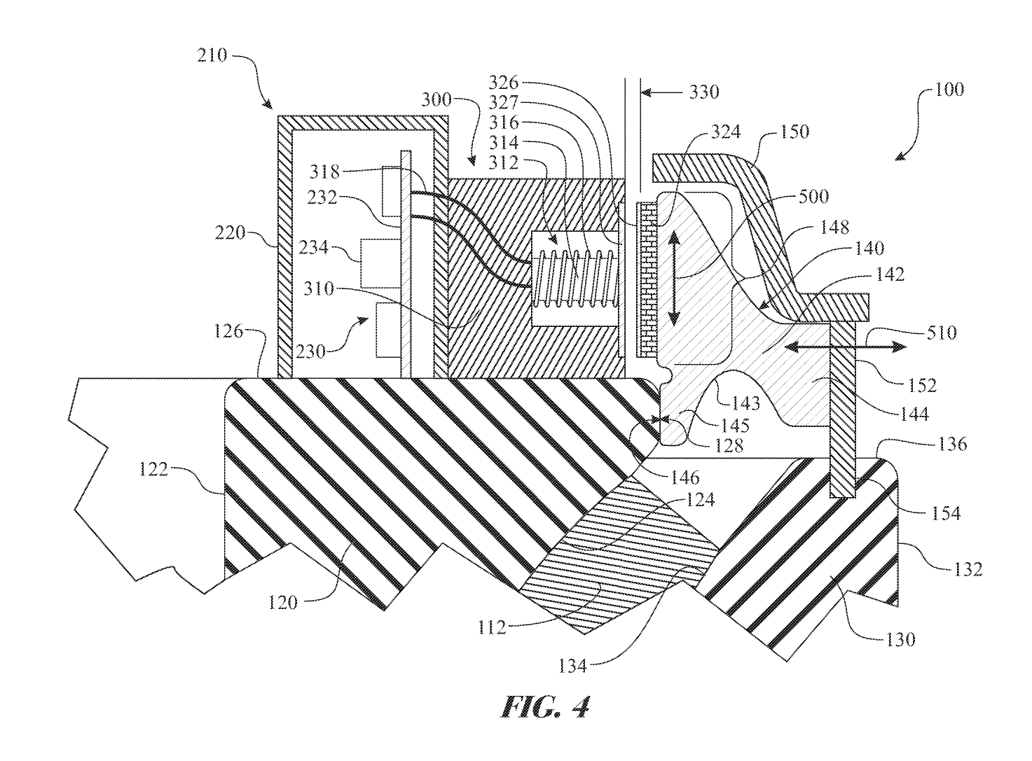

An exemplary embodiment of the power generating subassembly 200 is presented as a power generating subassembly 300 illustrated in FIGS. 2 through 4. Orientation references are represented by the directional lines illustrated in FIGS. 2 and 4. An axial direction 500 is parallel to the axis or rotation of the bearing rings 120, 130. A radial direction 510 is parallel to a radius of the bearing rings 120, 130. The illustrations present additional details of the bearing subassembly 110. Features of the bearing inner ring 120 can be referred to as: a bearing assembly interior engaging surface 122 defining an inner peripheral surface thereof; a bearing inner race engaging surface 124 defining an outer peripheral surface thereof; and an inner ring end surface 126 defining a planar end surface thereof. Features of the bearing outer ring 130 can be referred to as: a bearing outer surface 132 defining an outer peripheral surface thereof; a bearing outer race engaging surface 134 defining an inner peripheral surface thereof; and a planar outer ring end surface 136 defining an end surface thereof. At least one set of rollers or balls 112 can be assembled between the bearing inner ring 120 and bearing outer ring 130. The set of rollers or balls 112 can be selected from any configuration known by those skilled in the art. Alternatively, the surfaces 124, 134 can be slideably engaging. A bearing assembly seal lip 140 can be attached to one of the bearing rings 120, 130. The bearing ring that retains the bearing assembly seal lip 140 can be referred to as a sealing attachment bearing ring. The remaining ring is a respective rotational bearing ring. The exemplary embodiment couples the bearing assembly seal lip 140 to the bearing outer ring 130.

In the exemplary embodiment, the bearing subassembly 110 comprises a bearing assembly seal lip 140. The bearing assembly seal lip 140 spans across a gap or opening extending between the bearing inner ring 120 and bearing outer ring 130, wherein the bearing assembly seal lip 140 forms a seal therebetween. The bearing assembly seal lip 140 would be affixed to a sealing attachment ring, wherein the sealing attachment ring is one of the bearing outer ring 130 and the bearing inner ring 120, wherein the remaining ring is subsequently referred to as a respective rotational ring. The bearing assembly seal lip 140 is fabricated of any suitable sealing material, including rubber, nylon, and the like. A seal lip inner ring lip engaging surface 146 of the seal lip inner ring lip engaging segment 145 remains in contact with an inner ring sealing lip surface 128, providing a seal therebetween. The inner ring sealing lip surface 128 is defined as a section of the bearing inner ring 120 that extends proud from the outer ring planar end surface 136 of the bearing outer ring 130.

The seal lip inner ring lip engaging segment 145 can be shaped in any suitable geometry to optimize the sealing interface. The seal lip inner ring lip engaging segment 145 additionally retains the magnetically polarized material supporting member 148 at a desired spatial arrangement with the electrical power generator 310, thus retaining a consistent air gap 330. The bearing assembly seal lip 140 is provided as an annular ring (as best illustrated in FIG. 2), being continuous about the circumference of the interface between the bearing inner race engaging surface 124 and bearing outer race engaging surface 136 and concentrically about a central axis of the bearing subassembly 110. A magnetically polarized material-supporting segment 148 extends in an axial direction from the seal lip inner ring lip engaging segment 145 extending beyond the ring end surfaces 126, 136.

A bearing assembly seal lip 140 provides two functions. In a first function, the bearing assembly seal lip 140 provides a seal preventing unwanted materials from lodging themselves within the rolling interfaces between the bearing inner ring 120, the bearing outer ring 130 and the series of bearings 112. In a second function, the bearing assembly seal lip 140 includes a magnetically polarized material supporting segment 148, which provides support for an at least one magnetically polarized material 324 integrated thereto. Relative motion of the magnetically polarized material 324 respective to the generator core 312 causes an interaction between the magnetically polarized material 324 and the generator core 312 generating an electrical power output. A bearing seal cover 150 can be assembled to the bearing outer ring 130 using a bearing seal cover attachment member 152. The bearing seal cover 150 would be designed to allow pliant motion of the bearing assembly seal lip 140, while protecting the bearing assembly seal lip 140 from mechanical abrasion, exposure to the elements, and the like which would deteriorate the material. It is understood that the bearing seal cover attachment member 152 can be integrated into the bearing seal cover 150.

The bearing assembly seal lip body 142 and the magnetically polarized material supporting segment 148 are preferably fabricated as a unitary portion of the bearing assembly seal lip 140. The bearing assembly seal lip 140 would be formed in a continuous annular ring shape. The bearing assembly seal lip 140 includes a seal lip outer ring attachment segment 144, which is fastened directly or indirectly to the bearing outer ring 130. In the exemplary embodiment, the seal lip outer ring attachment segment 144 is joined to the bearing seal cover attachment member 152; the bearing seal cover attachment member 152 is assembled to the bearing outer ring 130. It is understood that the bearing seal cover attachment member 152 can be assembled to the bearing outer ring 130 using any assembly interface known by those skilled in the art. In the exemplary embodiment presented in FIG. 4, the bearing seal cover attachment member 152 is inserted into an attachment member receiving groove 154. The attachment member receiving groove 154 is formed radially about a length of the bearing outer ring 130. The bearing seal cover attachment member 152 can be press fit into the attachment member receiving groove 154, assembled using an adhesive, retained by a threaded or other mechanical fastener, and the like. The bearing assembly seal lip 140 is formed to include a seal lip inner ring lip engaging segment 145, which slideably engages with an inner ring sealing lip surface 128 of the bearing inner ring 120. A seal lip body compliancy formation 143 is formed in the bearing assembly seal lip body 142 providing pliancy between the seal lip outer ring attachment segment 144 and the seal lip inner ring lip engaging segment 145.

A magnetically polarized material 324 is integrated into the magnetically polarized material-supporting segment 148 in a manner to magnetically interact with a generator core 312 of an electrical power generator 310. The magnetically polarized material 324 can be any material or configuration of materials providing a variable reluctance. The magnetically polarized material 324 can be provided in a complete annular ring, a series of segments spatially arranged about the annular ring, or a single independent section along the annular ring. An optional magnetically polarized material coating 327, fabricated of any suitable friction-reducing material (described in detail below) may be applied to an exposed surface of the magnetically polarized material 324.

The electrical power generator 310 is included as a component of the power generating subassembly 300, wherein the electrical power generator 310 includes a generator core 312. The generator core 312 comprises an electrical coil 316 wound about a magnetic core 314. The electrical power generator 310 is assembled to the respective rotational ring orienting the generator core 312 in a radial direction to operationally interact with the magnetically polarized material 324.

An optional circumferential gliding material 326 can be attached to the electrical power generator 310, the circumferential gliding material 326 being attached upon a surface which is parallel and proximate the magnetically polarized material 324.

In operation, as the bearing inner ring 120 and bearing outer ring 130 rotate respective to one another, the generator core 312 passes across the magnetically polarized material 324. The magnetically polarized material 324 includes variations in magnetic properties, wherein as the magnetically polarized material 324 moves relative to the generator core 312, the variations in magnetic properties changes the magnetic flux of a magnetic core 314 integrated into the generator core 312. The change in magnetic flux creates an electrical current in an electrical coil 316 wrapped about the magnetic core 314. The electrical current is conveyed to other equipment by wires or other electrical conduits.

The circumferential gliding material 326 can be any friction reducing material, including Polytetrafluoroethylene (PTFE), and the like. PTFE is a synthetic fluoropolymer of tetrafluoroethylene that finds numerous applications. The most well known brand name of PTFE is Teflon™ manufactured by the DuPont Company™. Other materials, including Polyoxymethylene (POM), also known as acetal, polyacetal, and polyformaldehyde, is an engineering thermoplastic used in precision parts that require high stiffness, low friction and excellent dimensional stability The most well known exemplary brand name of POM is Delrin™, also manufactured by the DuPont Company™.

The illustrated exemplary configuration assembles the electrical power generator 310 to the bearing inner ring 120 and the bearing assembly seal lip 140 is affixed to the bearing outer ring 130. In this configuration, the magnetically polarized material-supporting segment 148 is subjected to a centrifugal force and retained in location by the circular ring shape. The magnetically polarized material supporting segment 148 can be retained by friction against the circumferential gliding material 326 or an air gap 330 between the magnetically polarized material 324 an the opposing surface of the electrical power generator 310. Additionally, the magnetically polarized material supporting segment 148 is retained at a distance from an opposing surface of the electrical power generator 310 by the engagement of the seal lip inner ring lip engaging surface 146 against the inner ring sealing lip surface 128, thus retaining a consistent span forming the air gap 330. The magnetically polarized material-supporting segment 148 portion of the bearing assembly seal lip 140 would at least partially incorporate a material that is relatively rigid, retaining its shape when subjected to stresses during operation and rotation of the bearing subassembly 110.

The electrical power generated by the generator core 312 would be transferred to the electronics subassembly 210 by one or more electrical conduits 318. The electronics subassembly 210 would include any electrical components desired for accomplishing a predetermined, integrated function. The exemplary embodiment includes a printed circuit assembly 230 assembled within an electronics housing 220. The electronics housing 220 protects the printed circuit assembly 230 from damage, exposure to the elements, contamination, vibration, noise, electrostatic charges, undesirable radio frequencies, contact with persons or other living animals, and the like. Electronics would be assembled within an interior defined by walls of the electronics housing 220. The electronics can include a printed circuit assembly 230 (as illustrated), a portable power storage device, a wireless transmitting circuit 298, a micro-processing device, a memory or other digital recording device, a power management circuit, one or more sensors, and the like. The exemplary printed circuit assembly 230 includes a plurality of electronic components 234 assembled to a printed circuit board 232. Power would be provided to the printed circuit assembly 230 from the generator core 312 by way of at least one electrical conduit 318.

It is understood that one electrical conductor can utilize electrically conductive properties of the electrical power generator 310, the electronics housing 220, and an electrical connection between the printed circuit board 232 and the electronics housing 220.

It is also understood that the electrical power generator 310 can be assembled to the bearing outer ring 130 and the sealing system 320 can be affixed to the bearing inner ring 120. In this alternate configuration, the magnetically polarized material supporting member 322 is subjected to a centrifugal force and retained in location by friction against the circumferential gliding material 326 or the air gap 330 between the magnetically polarized material 324 an the opposing surface of the electrical power generator 310. This configuration would require an offset between the bearing inner ring 120 and bearing outer ring 130 to define a lip on the bearing outer ring 130.

The power generating bearing assembly 100 provides several advantages over currently known bearing assemblies. The integration of a power generator enables utilization of electrically operated devices without requiring an external power source. The configuration reduces the quantity and length of electrical conductors, such as wires and the like, thus increasing the reliability of the overall apparatus. The integration of a power generator supports the utilization of sensors and other monitoring devices to monitor, analyze, and report on the condition of the bearing subassembly 110 over the lifespan of the machine. Integrating the power generating system into the bearing assembly seal lip 140 reduces weight, and thus lowers the inertial impact upon the bearing subassembly 110. The integrated solution also reduces a cost of the components as well as assembly of the power generating bearing assembly 100.

The integration of the magnetically polarized material 324 into the bearing assembly seal lip 140 provides compensation for offset motions during operation of the power generating bearing assembly 100. The distance between the magnetically polarized material 324 and the generator core 312 is critical when utilizing a magnetic interface for generating an electrical power. In a condition where the magnetically polarized material 324 is too close to the generator core 312, the magnetic attraction would impact the rotational motion of the bearing outer ring 130 respective to the bearing inner ring 120, thus reducing the efficiency. This would also increase the output voltage, which can be a problem, especially since it increases with speed. In a condition where the magnetically polarized material 324 is too far from the generator core 312, the magnetic attraction would be reduced, thus lowering the efficiency of the generation of the electrical power. The output voltage would also decrease, which could cause a problem for any attached consumer. Therefore, it is critical to retain the distance of the air gap 330 as designed. The seal lip inner ring lip engaging segment 145 is supported by the sliding engagement between the seal lip inner ring lip engaging surface 146 and the inner ring sealing lip surface 128. This engagement retains the magnetically polarized material-supporting segment 148 at a designed distance from the interfacing surface of the generator core 312. The seal lip body compliancy formation 143 compensates for radial motion 510 between the bearing inner ring 120 and bearing outer ring 130. Additionally, the engagement between the seal lip inner ring lip engaging surface 146 and the inner ring sealing lip surface 128 enables the bearing assembly seal lip 140 to absorb vibrations without impacting the air gap 330.

Axial discrepancies between the magnetically polarized material 324 and the operational surface of the generator core 312 are compensated by design. The magnetically polarized material 324 has an axial dimension enabling a full range of motion across the operational face of the generator core 312 to compensate for axial motion 500 during operation of the power generating bearing assembly 100. The axial dimension of the exposed face of the magnetically polarized material 324 would be sufficiently greater than the axial dimension of the operational face of the generator core 312 to ensure suitable registration and engagement between the magnetically polarized material 324 and the generator core 312 at any time of inflection of axial motion between the bearing inner ring 120 and the bearing outer ring 130. It is understood that the desired assembly would align a center of the magnetically polarized material 324 with the center of the generator core 312 for a bearing subassembly 110 that is designed to have symmetric axial motion 500. Should the bearing subassembly 110 be designed or integrated into a system that would anticipate an asymmetrical axial motion 500, the initial registration would be offset accordingly.

By retaining a constant distance between opposing surfaces of the magnetically polarized material 324 and the electrical power generator 310, the system optimizes the energy generation, while minimizing any frictional or other reduction in mechanical, rotational efficiencies.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### REF. NO. DESCRIPTION

100 power generating bearing assembly
110 bearing subassembly
112 bearing
120 bearing inner ring
122 bearing assembly interior engaging surface
124 bearing inner race engaging surface
126 inner ring planar end surface
128 inner ring sealing lip surface
130 bearing outer ring
132 bearing outer surface
134 bearing outer race engaging surface
136 outer ring planar end surface
140 bearing assembly seal lip
142 bearing assembly seal lip body
143 seal lip body compliancy formation
144 seal lip outer ring attachment segment
145 seal lip inner ring lip engaging segment
146 seal lip inner ring lip engaging surface
148 magnetically polarized material supporting segment
150 bearing seal cover
152 bearing seal cover attachment member
154 attachment member receiving groove
200 power generating subassembly
210 electronics subassembly
220 electronics housing
230 printed circuit assembly
232 printed circuit board
234 electronic component
250 processing unit
252 output device
254 user input device
296 wired signal interface
298 wireless signal interface
300 power generating subassembly
310 electrical power generator
312 generator core
314 magnetic core
316 electrical coil
318 electrical conduits
324 magnetically polarized material
326 circumferential gliding material
327 magnetically polarized material coating
330 air gap
500 axial direction
510 radial direction

1. A power generating bearing assembly, comprising:
a bearing comprising:
a bearing outer ring having an outer surface, a bearing outer race engaging surface, and an outer ring end surface,
a bearing inner ring having a bearing assembly interior mating surface, a bearing inner race engaging surface, and an inner ring planar end surface, wherein the bearing inner race engaging surface is sized to rotationally engage with the outer ring bearing outer race engaging surface,
wherein the inner ring is rotatationally assembled within the outer ring bearing outer race engaging surface and the inner ring planar end surface stands proud from the outer ring end surface exposing and defining an inner ring sealing lip surface,
a bearing assembly seal lip comprising a bearing assembly seal lip body segmented into a seal lip outer ring attachment segment, a seal lip inner ring lip engaging segment, and a magnetically polarized material supporting segment, the magnetically polarized material supporting segment extending axially from the seal lip inner ring lip engaging segment beyond the inner ring planar end surface,
a magnetically polarized material carried by the magnetically polarized material supporting segment,
wherein the seal lip outer ring attachment segment is mechanically coupled to the bearing outer ring and a seal lip inner ring lip engaging surface of the seal lip inner ring lip engaging segment slideably engages with the inner ring sealing lip surface; and
an electrical power generator including a generator core to generate electrical power when exposed to an interactively paired magnetically polarized material, the electrical power generator being attached to the bearing inner ring orienting the generator core in a radial direction to operationally engage with the magnetically polarized material;
wherein during operation, engagement between a seal lip inner ring lip engaging surface of the seal lip inner ring lip engaging segment and the inner ring sealing lip surface retains a consistent distance between the magnetically polarized material and an operational face of the electrical power generator and a relative motion between the bearing outer ring and the bearing inner ring passes the magnetically polarized material across the generator core causing the generator core to create an electrical current.

2. A power generating bearing assembly as recited in claim 1, the bearing assembly further comprising a series of rollers or balls, wherein the inner ring is rotatationally assembled within the outer ring bearing outer race engaging surface integrating the series of rollers or balls there between.

3. A power generating bearing assembly as recited in claim 1, the bearing assembly seal lip further comprising a seal lip body compliancy formation formed between the seal lip outer ring attachment segment and the seal lip inner ring lip engaging segment.

4. A power generating bearing assembly as recited in claim 1, the magnetically polarized material has an axial dimension that is larger than an axial dimension of the operational face of the electrical power generator wherein the dimensional difference accommodates relative axial motions between the bearing inner ring and the bearing outer ring during operation.

5. A power generating bearing assembly as recited in claim 1, wherein the magnetically polarized material supporting segment is formed as an annular ring concentric about a central axis of the bearing.

6. A power generating bearing assembly as recited in claim 5, the magnetically polarized material being provided as an annular ring.

7. A power generating bearing assembly as recited in claim 5, the magnetically polarized material being provided in a partial circumference of the annular ring.

8. A power generating bearing assembly as recited in claim 5, the magnetically polarized material being provided in a plurality of segments, the plurality of segments being spatially arranged about a circumference of the annular ring.

9. A power generating bearing assembly, the power generating bearing assembly comprising:
a bearing comprising:
a bearing inner ring having an inner surface, a bearing inner race engaging surface, and an inner ring end surface,
a bearing outer ring having a bearing assembly outer mating surface, a bearing outer race engaging surface, and an outer ring planar end surface, wherein the bearing outer race engaging surface is sized to rotationally engage with the inner ring bearing inner race engaging surface,
a series of rollers or balls,
wherein the inner ring is rotationally assembled within the outer ring bearing outer race engaging surface integrating the series of rollers or balls there between and the outer ring planar end surface stands proud from the inner ring end surface exposing and defining an outer ring sealing lip surface,
a bearing assembly seal lip comprising a bearing assembly seal lip body segmented into a seal lip inner ring attachment segment, a seal lip outer ring lip engaging segment, and a magnetically polarized material supporting segment, the magnetically polarized material supporting segment extending axially from the seal lip outer ring lip engaging segment beyond the outer ring planar end surface,
a magnetically polarized material carried by the magnetically polarized material supporting segment,
wherein the seal lip inner ring attachment segment is mechanically coupled to the bearing inner ring and a seal lip outer ring lip engaging surface of the seal lip outer ring lip engaging segment slideably engages with the outer ring sealing lip surface; and
an electrical power generator including a generator core to generate electrical power when exposed to an interactively paired magnetically polarized material, the electrical power generator being attached to the bearing outer ring orienting the generator core in a radial direction to operationally engage with the magnetically polarized material;
wherein during operation, engagement between a seal lip outer ring lip engaging surface of the seal lip outer ring lip engaging segment and the outer ring sealing lip surface retains a consistent distance between the magnetically polarized material and an operational face of the electrical power generator and a relative motion between the bearing inner ring and the bearing outer ring passes the magnetically polarized material across the generator core causing the generator core to create an electrical current.

10. A power generating bearing assembly as recited in claim 9, the bearing assembly seal lip further comprising a seal lip body compliancy formation formed between the seal lip inner ring attachment segment and the seal lip outer ring lip engaging segment.

11. A power generating bearing assembly as recited in claim 9, the magnetically polarized material has an axial dimension that is larger than an axial dimension of the operational face of the electrical power generator to accommodate for axial relative motions between the bearing outer ring and the bearing inner ring during operation.

12. A power generating bearing assembly as recited in claim 9, wherein the magnetically polarized material supporting segment is formed as an annular ring concentric about a central axis of the bearing.

13. A power generating bearing assembly as recited in claim 9, the magnetically polarized material being provided as an annular ring.

14. A power generating bearing assembly as recited in claim 9, the magnetically polarized material being provided in a partial circumference of the annular ring.

15. A power generating bearing assembly as recited in claim 9, the magnetically polarized material being provided in a plurality of segments, the plurality of segments being spatially arranged about a circumference of the continuous ring.
